(19) United States
(12) Patent Application Publication
(10) Pub. No.: US 2012/0049041 A1
(43) Pub. Date: Mar. 1, 2012

(54) SWITCHED RAIL CIRCUITRY AND MODIFIED CELL STRUCTURE AND METHOD OF MANUFACTURE AND USE

(75) Inventor: John J. ELLIS-MONAGHAN, Grand Isle, VT (US)

(73) Assignee: INTERNATIONAL BUSINESS MACHINES CORPORATION, Armonk, NY (US)

(21) Appl. No.: 12/873,694

(22) Filed: Sep. 1, 2010

(51) Int. Cl. H01L 27/146

(52) U.S. Cl. 250/208.1; 257/E27.133

(57) ABSTRACT

A switched rail circuitry and modified cell structure is provided. More specifically, switched rail pixels with pull-up circuitry and a method of manufacture is provided. The pixel sensor circuit includes a switched rail line having a pull-up transistor, wherein the pull-up transistor is coupled to a supply voltage Vdd.

### FIELD OF THE INVENTION

The invention relates to switched rail circuitry and modified cell structure and, more particularly, to switched rail pixels with pull-up circuitry and a method of manufacture.

### BACKGROUND

An image sensor is a device that converts an optical image to an electric signal. It is used mostly in digital cameras and other imaging devices. Current image sensors are typically, for example, a charge-coupled device (CCD) or a complementary metal-oxide-semiconductor (CMOS) active-pixel sensor cell. In a CMOS active-pixel sensor cell, circuitry is needed next to each photo sensor (diode) to convert the light energy to a voltage. Additional circuitry on the chip is also included to convert the voltage to digital data. The circuitry receives power from Vdd through a switched rail line Vdd.

However, current architectures suffer from Vdd droop down the switched rail line Vdd. For example, Vdd degrades as the column number increases due to the IR voltage drop going down the switched rail line Vdd, and being pulled off for each column line. This continues to get worse with more columns. For example, the droop can amount to about 15% less electrons being read out of the column, over an approximate 500 column span. Also, with Vdd droop, the dynamic range of the active-pixel sensor cell can be limited and the fixed pattern noise will increase.

Accordingly, there exists a need in the art to overcome the deficiencies and limitations described hereinabove.

### SUMMARY

In a first aspect of the invention, a pixel sensor circuit comprises a switched rail line having a pull-up transistor. The pull-up transistor is coupled to a supply voltage Vdd.

In another aspect of the invention, a pixel sensor circuit comprises at least one cell comprising a photodiode in series with a transfer transistor coupled between a switched rail line and a transistor leading to a common column line. The pixel sensor circuit further comprises a pull-up transistor coupled to the cell by the switched rail line.

In yet another aspect of the invention, a method of preventing Vdd droop in a pixel sensor circuit, comprises: providing a cell having a photodiode, transfer transistor, a reset transistor and a transistor coupled between the transfer transistor and a common column line; providing Vdd rail line coupled to the cell that can be switched to a high state by a source Vdd; and providing at least one pull-up transistor in the Vdd rail line.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 shows an electrical schematic diagram of a switched rail circuitry in accordance with aspects of the invention;

FIG. 2 shows an electrical schematic diagram of a switched rail circuitry in accordance with aspects of the invention;

FIG. 3 shows a random pixel placement in an array in accordance with aspects of the invention;

FIGS. 4a and 4b show a comparison of a conventional switched rail circuitry and a switched rail circuitry in accordance with aspects of the invention; and

FIG. 5 is a representative flow diagram showing a method of manufacturing the switched rail circuitry in accordance with aspects of the invention.

### DETAILED DESCRIPTION

The invention relates to a switched rail circuitry and modified cell structure and, more particularly, to switched rail pixels with pull-up circuitry and a method of manufacture. In embodiments, the switched rail circuitry of the present invention includes a pull-up (boost enable) transistor in the switched rail line, designed to be periodically pulled to Vdd. In embodiments, the present invention contemplates disabling an occasional pixel in the array and using this pixel location for the pull-up transistor. For example, the present invention can replace a green pixel every 200-500 instances, on a random basis. Amongst other applications, the present invention can be used in a rolling shutter application or global shutter application.

Advantageously, with the present invention, the switched Vdd rail line will not droop because it can be held up at multiple locations along the row. Accordingly, as there is no Vdd droop, the dynamic range of the circuit of the present invention can be increased and the fixed pattern noise can be decreased. Additionally and advantageously, the switched Vdd rail line can be more resistive without performance penalty, and the speed of readout (frames/sec.) can be increased since the pixel Vdd will settle much more quickly. The latter feature provides benefits especially to video applications.

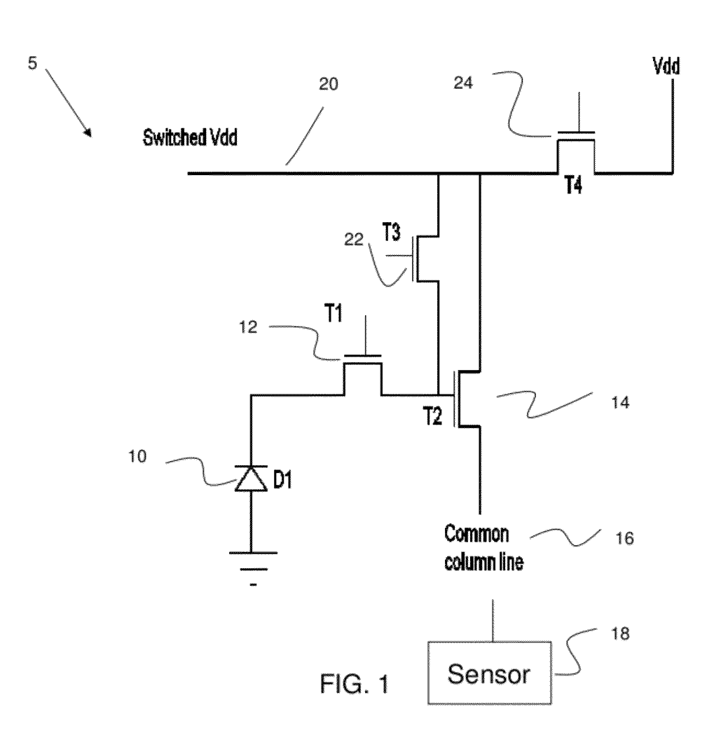

FIG. 1 shows an electrical schematic diagram of a switched rail circuitry in accordance with aspects of the invention. More particularly, FIG. 1 shows switched rail circuitry 5 which includes a photodiode D1, 10, in series with a transfer transistor T1, 12. As should be understood by those of skill in the art, the photodiode D1, 10, is sensitive to light, such that light will change potential across the photodiode D1, 10. In embodiments, the transfer transistor T1, 12, when turned on, transfers the potential from the photodiode D1, 10, to transistor T2, 14. The voltage can then be passed to the common column line 16 and to a sense amplifier 18. The transistor T2, 14 is also electrically coupled to a switched Vdd rail line 20 along the row.

The switched rail circuitry 5 also includes a reset transistor T3, 22. The reset transistor T3, 22 is electrically coupled to the switched Vdd rail line 20 and an input to the transistor T2, 14. A pull-up (boost enable) transistor T4, 24, is provided in the switched Vdd rail line 20. More specifically, the pull-up transistor T4, 24 is coupled to a supply voltage Vdd, via the switched Vdd rail line 20. The pull-up transistor T4, 24 will pull-up the switched Vdd rail line 20.

As an example of operation, when the switched Vdd rail line 20 is at a high potential, the reset transistor T3, 22, and transfer transistor T1, 12 can be turned on to reset the photodiode D1, 10. Then, with the reset transistor T3, 22, still turned on, the switched Vdd can be pulled low, e.g., about 0.5 volts. The low voltage is transferred to the gate of transistor T2, 14, turning off T2. When the transistor T2, 14, is turned off, no current will be leaked to the column line 16. The pull-up transistor T4, 24, may be turned on to pull up the switched Vdd rail 20 to the high voltage condition (3.3 v) during read operations to prevent Vdd droop.

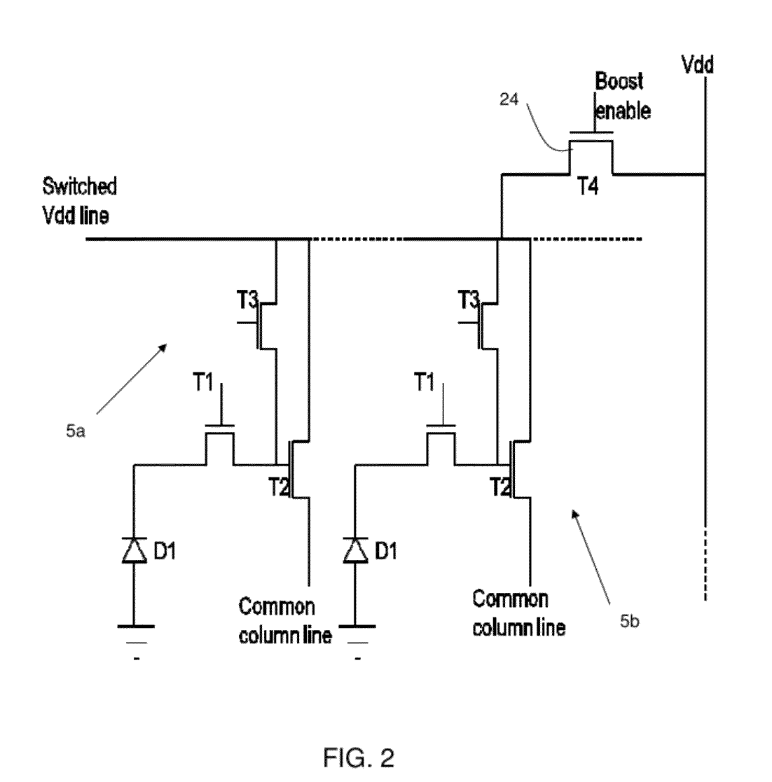

In embodiments, the pull-up transistor T4, 24, may be in every repeating cell (circuit 5) or may be shared with multiple other cells (circuit 5) along the row. For example, FIG. 2 shows the pull-up transistor T4, 24, shared amongst two cells, e.g., circuit 5a and 5b. It should be understood that the pull-up transistor T4, 24, may be shared amongst more than two cells (circuits). As discussed in more detail below, in operation, the pull-up transistor T4, 24, is on when the switched Vdd rail line 20 is high (e.g., about 3.3 volts); whereas, the pull-up transistor T4, 24, is off when the switched Vdd rail line 20 is low (e.g., about 0.5 volts). Advantageously, the switched Vdd rail line 20 will not droop because it can be held up at multiple locations along the row using the pull-up transistor T4, 24 at one or multiple locations.

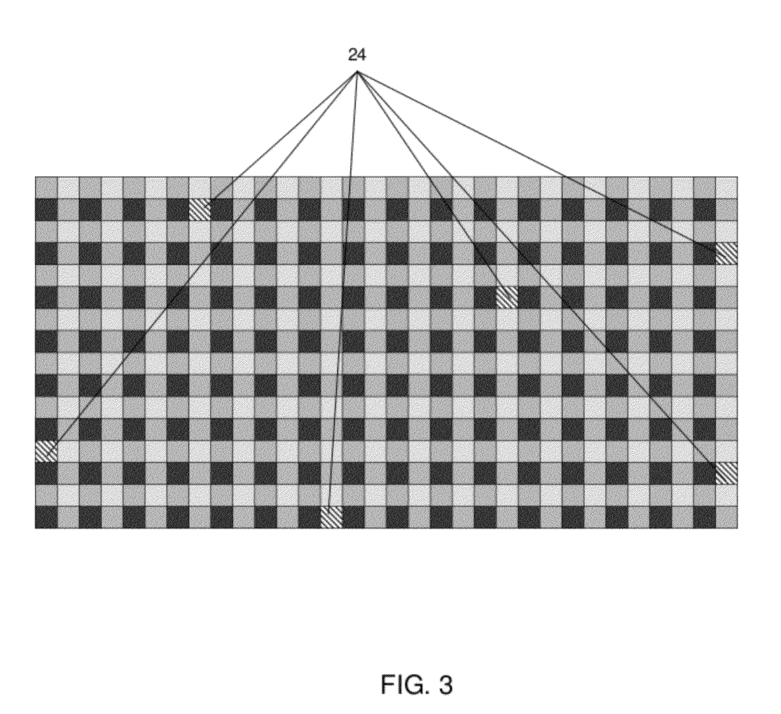

FIG. 3 shows a random pixel replacement representation in accordance with aspects of the invention. In embodiments, the pull-up transistor T4, 24, is placed at different locations within the pixel sensor cell (circuit). In this representation, an occasional pixel in the array would be disabled and replaced with the pull-up transistor T4, 24 (or used as a pull-up transistor). In embodiments, the pixels are selected such the locations for the pull-up transistor T4, 24, would not affect picture quality. In embodiments, the pattern is random; although a repeating pattern can be used so long as the pixels are of sufficient distance as to not affect the picture quality. For example, the locations for a pull-up transistor T4, 24, can be placed one in each row and column of the array. As another example, the pull-up transistor T4, 24, can replace a green pixel every 200-500 instances, on a random basis.

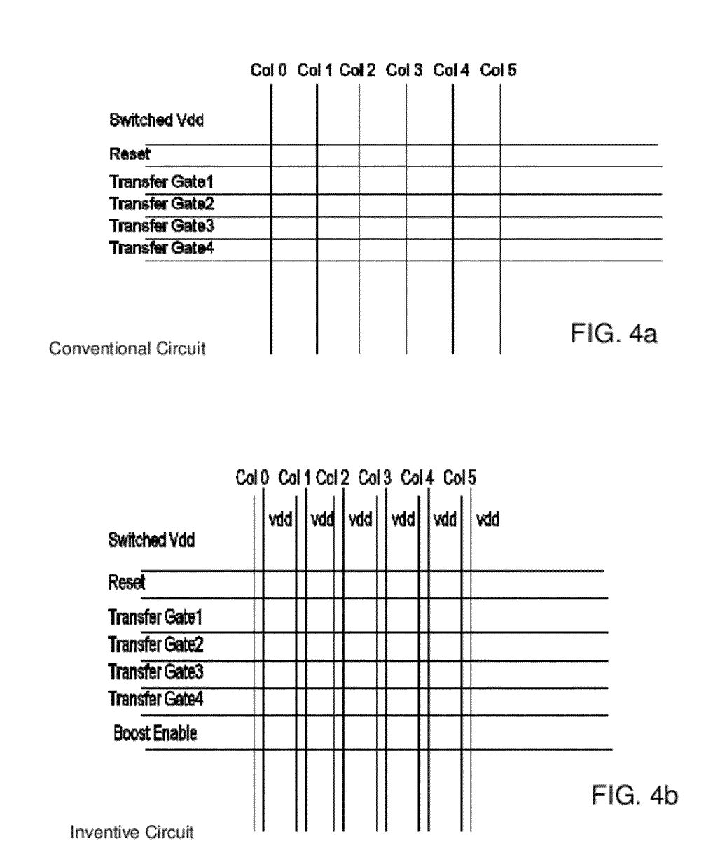

FIGS. 4a and 4b show a comparison between a conventional circuit and the circuits in accordance with the present invention. As seen from FIG. 4a, a conventional circuit has only a single line per group. This is in comparison to FIG. 4B, in which the circuit of the present invention provides an extra horizontal line (boost enable) and an extra vertical line per shared grouping. Although this representation shows five (5) columns, it should be understood by those of skill in the art that more or less than five columns are contemplated by the present invention.

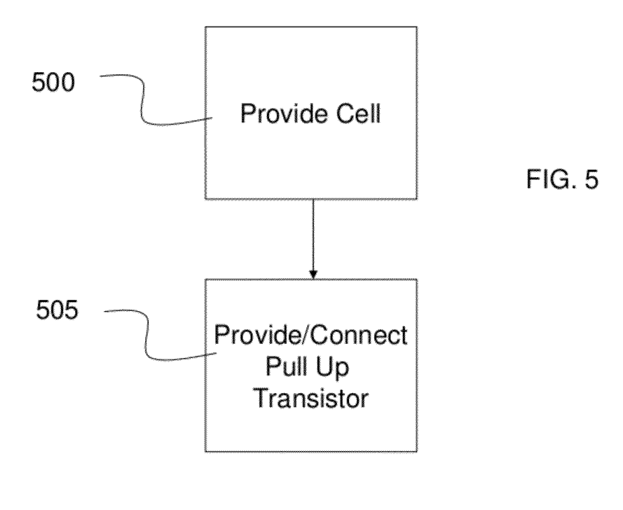

FIG. 5 is a representative flow diagram showing a method of manufacturing the switched rail circuitry in accordance with aspects of the invention. In particular, step 500 is representative of providing a cell having a photodiode, transfer transistor, a reset transistor and a transistor coupled between the transfer transistor and a common column line. The circuitry also includes a Vdd rail line that can be switched to a high state by a source Vdd. In embodiments, the providing step includes conventional formation of these devices using known CMOS fabrication techniques such as, for example, conventional deposition and patterning steps. For example, the transistors can each be formed using conventional oxide and gate formation, e.g., deposition of dielectric materials, and gate materials such as, for example, poly or metal, with patterning steps. Nitride spacers/sidewalls can be formed on the sides of the gate structures, with a doping process being performed to form the source and drain regions, as well as extension implants and halo implants, if required. The Vdd rail line and other connections between the circuitry can be made by conventional deposition and patterning of wiring layers.

The method further includes, at step 505, providing at least one pull-up transistor in the Vdd rail line. This providing step may include connecting at least one pull-up transistor to the cell using the Vdd rail line. In embodiments, the pull-up transistor can be provided for each cell or for multiple cells along the row. The pull-up transistor can also be made using conventional deposition and patterning steps, with connections made by conventional wiring techniques.

### Example of Use

The circuit of the present invention can be in a standby mode, a reset mode or a correlated double read operation mode. In the standby mode, for example, no current will flow into the column from a pixel. In a reset mode, the photodiode D1, 10, can be reset. In the correlated double read operation mode, the value of the photodiode on the transistor T2, 14, can be sent to the common column line to be read by a sense amp, for example. In the examples below, a 3.3 V power supply is assumed; although this should not be considered a limiting feature of the present invention as the power supply can be scaled.

In the standby mode, the boost enable (pull-up transistor T4, 24) is set to low, e.g., ground of 0 V. In this state, the Vdd is disconnected from the switched Vdd rail line 20, which is set to low, e.g., about 0.5 V. The gate of the reset transistor, T3, 22, is set high, e.g., about 3.3 V, which connects the gate and drain of the transistor T2, 14, to 0.5 V. As such, the column line is either floated or pulled to a relatively high voltage by another row's operation. This results in the common column line 16 being biased to greater than 0.5 V. It follows that no current will flow into the column from this pixel (e.g., Vgs=0 and Vsb=−0.5 V).

In the reset mode, the boost enable (e.g., transistor T4, 24) is set high, e.g., typically Vdd+Vt≈4 V. This pulls the switched Vdd rail line 20 (in this example, about 3.3 V) to Vdd. The driven switched Vdd rail line 20 can be either driven to Vdd or tri-stated (e.g., set to a high impedance (on left side) and pulled to any potential), in which case the pull-up transistor T4, 24, is relied upon to pull the switched Vdd rail line 20 to Vdd (e.g., about 3.3 V in this example). The reset transistor T3, 22, is pulled high (e.g., about 3.3V to 4V) and the transfer transistor T1, 12, is turned on (e.g., about 3.3V to 4V). This results in the diode D1, 10, being reset pulling all the electrons out of the pinned photodiode. The timing then proceeds to turn off the gate of the transfer transistor T1, 12, and turn off the pull-up transistor T4, 24. Then the switched Vdd rail line 20 is driven by the row driver (from a high state, e.g., about 3.3 V) to about 0.5V, which then places the circuit 5 back to the standby mode.

The present invention can also be used for a correlated double sample read operation. In a first operation, a floating diffusion only is reset. As should be understood by those of skill in the art, a floating diffusion is the circuit node attached to the gate of the transistor T2, 14. Starting from the standby mode, the floating diffusion is reset by turning on the reset transistor T3, 22, and the pull-up transistor T4, 24. The switched Vdd rail line 20 will be brought high (e.g., about 3.3 V to 3.7 V) by the pull-up transistor T4, 24, and may optionally also be driven high by the row driver circuitry. Then, the reset transistor T3, 22, is brought down to ground.

Next, the value on the column line is read by the column circuitry (typically stored on a capacitor). In one example, the value is approximately 1.5 V, which can be passed along to an analog to digital convertor. In embodiments, the 1.5 V is a reference voltage.

In a second operation of the read mode, the photodiode D1, 10, is read. In this operation, the gate of the transfer transistor T1, 12, is brought high (e.g., about 3.3 V) which drives the charge from the photodiode D1, 10, onto the floating diffusion and the gate of the transistor T2, 14. The gate of the transfer transistor T1, 12, is brought down. Next, the value on the column line is read by the column circuitry (typically stored on a second capacitor). The reset of the column circuitry will then subtract the two signals for a low noise differential reading. The gate of the transfer transistor T1, 12, will also passively reset at the same time as the read. The transistor T4, 24, is turned off and the reset transistor T3, 22, is turned on, and the row drives are used to drive the switched Vdd rail line 20 to about 0.5V. The circuit 5 is again back to the standby mode.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principals of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

What is claimed:

1. A pixel sensor circuit comprising a switched rail line having a pull-up transistor, wherein the pull-up transistor is coupled to a supply voltage Vdd.

2. The pixel sensor circuit of claim 1, wherein the pull-up transistor pulls up the switched rail line to Vdd.

3. The pixel sensor circuit of claim 1, wherein the pull-up transistor pulls up the switched rail line to Vdd at each column.

4. The pixel sensor circuit of claim 1, wherein the pull-up transistor is randomly arranged in a pixel array.

5. The pixel sensor circuit of claim 1, wherein the pull-up transistor is configured and placed within a circuit to prevent Vdd droop.

6. The pixel sensor circuit of claim 1, wherein the pull-up transistor is placed in every repeating cell.

7. The pixel sensor circuit of claim 1, wherein the pull-up transistor is shared with multiple cells along a row.

8. The pixel sensor circuit of claim 1, wherein the pull-up transistor is structured and located to prevent Vdd droop along the switched rail line at multiple locations along a row.

9. The pixel sensor circuit of claim 1, wherein the pull-up transistor is on when the switched rail line is high and the pull-up transistor is off when the switched rail line is low.

10. A pixel sensor circuit comprising:
at least one cell comprising a photodiode in series with a transfer transistor coupled between a switched rail line and a transistor leading to a common column line; and
a pull-up transistor coupled to the cell by the switched rail line.

11. The pixel sensor circuit of claim 10, wherein the pull-up transistor pulls up the switched rail line to Vdd at each column.

12. The pixel sensor circuit of claim 10, wherein the pull-up transistor is randomly arranged in a pixel array.

13. The pixel sensor circuit of claim 10, wherein the pull-up transistor prevents Vdd droop along the switched rail line.

14. The pixel sensor circuit of claim 10, wherein the pull-up transistor is placed in every repeating cell.

15. The pixel sensor circuit of claim 10, wherein the pull-up transistor is shared with multiple cells along a row.

16. The pixel sensor circuit of claim 10, wherein the pull-up transistor is on when the switched rail line is high and the pull-up transistor is off when the switched rail line is low.

17. The pixel sensor circuit of claim 10, wherein the pull-up transistor is randomly placed in a pixel array by disabling an occasional pixel.

18. A method of preventing Vdd droop in a pixel sensor circuit, comprising:
providing a cell having a photodiode, transfer transistor, a reset transistor and a transistor coupled between the transfer transistor and a common column line;
providing Vdd rail line coupled to the cell that can be switched to a high state by a source Vdd; and
providing at least one pull-up transistor in the Vdd rail line.

19. The method of claim 18, wherein the providing the at least one pull-up transistor includes connecting the least one pull-up transistor to the cell using the Vdd rail line.

20. The method of claim 18, wherein the pull-up transistor is provided for each cell or for multiple cells along a row.
